(19) United States
(12) Patent Application Publication
(10) Pub. No.: US 2003/0088524 A1
(43) Pub. Date: May 8, 2003

(54) Method and system for determining user fees incurred from the use of an automation system

(76) Inventor: Volker Bibelhausen, Detmold (DE)

Correspondence Address: CHARLES E. BAXLEY, ESQUIRE, Hart, Baxley, Daniels & Holton, 59 John Street, Fifth Floor, New York, NY, 10038, US

(21) Appl. No.: 10/261,176

(22) Filed: Oct. 1, 2002

(30) Foreign Application Priority Data
Nov. 3, 2001 (DE) 101 54 112.0

(51) Int. Cl. G06F 17/60

(52) U.S. Cl. 705/400

(57) ABSTRACT

The present invention [relates to the] is a method and system for determination of user fees incurred from [the] use of [a] an automation system by [a] an automation system user for at least one automation system component made available by [the] a supplier. The [object of the] present invention [is to indicate] provides a way to easily determine such user fees[,] without running [the] a risk of having to disclose internal production data[,] and simultaneously [keeping the] keep number of actions required from the automation system user as low as possible. To this end, the present invention proposes that user data allocatable to the automation system component be acquired using a first data processor connected with the automation system[, the]. The acquired user data [be] is transmitted by the first data processor to a second data processor located on [the] a supplier side[, and the]. The user fees [be] are determined as a function of the transmitted user data using the second data processor.

### BACKGROUND OF THE INVENTION

1. [Description] Field of the Invention

The present invention relates to a method and a system for determining user fees. More particularly, the present invention relates to a method and a system for determining user fees incurred from the use of [a] an automation system by a user for at least one automation system component made available by [the] a supplier.

2. Description of the Prior Art

Component suppliers of machines or tools are known to lease them to customers. Such machines or tools often comprise individual components of [a] an automation system operated by the customer, for example in [the area] areas of automation, power distribution, building system control, and/or the automotive industry.

Therefore, [the] use of the machines or tools by the customer represents an immediate component of [the] a production or operating process based on [the] a respective automation system in [the] a case of [a] an automation system user. A fee depending on [the] a respective use can be charged to the operator, i.e., customer, for using the automation system component[, wherein the]. The individual automation system components remain the property of the supplier[,] or can be purchased proportionally by the customer[,] so as to cover [the] replacement of individual automation system components[, for example,] with [the] a user fee.

If [the] a respective automation system component-specific use is measured by suitable counters for registering fabricated product numbers and/or appropriately adjusted sensors or actuators, the component supplier can basically charge a fee based on [the] a respective use using these data.

Methods and systems are already known for transmitting automation system-specific data between spatially separate applications or devices, in particulars in areas of automation, power distribution, and/or building system control.

DE-C-199 04 331 [relates to the] teaches transmission of data via the [internet, wherein a first] Internet. First and second transmission [channel] channels are established on an [internet] Internet server of an automation system proceeding from a client via [a] an [internet] Internet connection using [a] first and second connection [request; the] requests. The transmission channels are provided to bidirectionally send and receive user data between the client and [internet] the Internet server via the [internet] Internet independent of time. In addition, [a] an unlimited duration of use for the transmission channels is ensured[,] so that apparent data can be sent even given [the] an absence of user data to maintain the transmission channels.

[However, such] Such a bi-directional connection, however, also allows the client, i.e., an outside source, to modify automation system-specific parameters, and hence remotely monitor the automation system[,] or specific data[, e.g.,] which might contain manufacturing know-how. As a consequence, this type of procedure or system is associated with serious disadvantages for numerous users or system operators[,] since [a] viewing of internal data records is often not desired, and hence not tolerated.

EP-A-0 964 325 [relates to the] teaches maintenance of field equipment[, wherein status]. Status and/or diagnostic data are gathered within a system process via a communication interface, based on which status or event data or messages, e.g., alarms or error messages, are initially generated, which are then relayed to another application, for example to software suitable for monitoring[,] or [to] for another purpose.

### SUMMARY OF THE INVENTION

The object of the present invention is to [indicate] provide a way to easily determine [the] user fees incurred by [the] use of [a] an automation system by [a] an automation system user for automation system components provided by a supplier[,] without running [the] a risk of having to disclose internal production data[,] and simultaneously keeping [the] number of actions required from the automation system user as low as possible.

[The object is achieved according to the invention by a method with the features in claim 1, or by a system with the features in claim 10.

The respective subclaims relate to advantageous and/or preferred forms of execution or further developments.]

Therefore, to determine [the] user fees incurred by [the] use of [a] an automation system by [a] an automation system user for at least one [of] component of the automation system provided by at least one component supplier, the present invention provides for determining [the] user data to be allocated to [the] a specific system component using a first data processor linked with the automation system, transmitting [the] acquired user data via the first data processor to a second data processor situated on [the] a respective supplier side, preferably in respectively selected time intervals, and [determine] determining the user fees as a function of the transmitted user data using the second data processor.

The advantage [here] is that user data are generated and sent to the component supplier for invoicing purposes according to the present invention [proceeding from the application, i.e.,] with the automation [systems] system in operation. Since only [the] data required by the component supplier for invoicing or determining user fees is [here] sent to the latter, internal production data that would disclose manufacturing know-how or product numbers [can then not] cannot be directly reproduced by the supplier.

Since a data transfer connection is also advantageously established only from the first data processor to the second data processor for transmitting the user data[, i.e.,] so that bi-directional sending and receiving is prevented, the automation system user need not be concerned that internal production data will be disclosed[,] or [the] that a production and/or operating process can be viewed or manipulated from without. Rather, it is ensured that a supplier of automation system components will only receive [the] data it needs to determine the user fees.

It is also advantageously provided that data concerning wear on the automation system components are acquired as user data. Suited for this purpose in particular is information about [the] number of pulses, prevailing temperatures, weights acting on individual components or volumes to be held, lengths to be spanned, revolutions to be performed, [the] accrued operating hours and corresponding downtimes, countable product numbers or liquid throughputs to be handled, and/or [the] number of set spot welds.

The resultant advantage is that not just precise user fees can be determined on [the] a supplier side based on actual use, but also wear and/or diagnostic data can be obtained from the user data transmitted on the supplier side[,] so that the supplier can independently and quickly gain information about necessary maintenance to ensure [the] respective system-specific use without the automation system user having to do anything.

In another preferred embodiment, the present invention provides that the first and/or second data [processor] processors can each be allocated to an internal network and/or the first and/or second data [processor comprises] processors comprise a networkable gateway[,] so that[, in a practical further development,] the data transfer connection from the first data processor to the second data processor is established using a network, in particular the [internet] Internet.

Therefore, the data processor allocated to the automation system practically functions as a server, which[,] in another advantageous embodiment, transmits [the] necessary data independently in predefined time intervals[,] and/or prepares [this] the data in response to a corresponding request previously conveyed to the server by the second data processor. In other words, [the] a server side is located at the automation system user[,] and [the] a client side at the supplier. The server sends [the] necessary user data via [the] a network to the client, which preferably gathers these data and cyclically generates an invoice based on [the] determined user fees for the automation system user.

[In an especially practical further development, the] The present invention also provides that system components provided by various suppliers are also acquired relative to their respective user data[, and the]. The acquired user data are transmitted specific to the supplier by the first data processor to the second data processor located on the respective supplier side.

Since automation system users generally procure their various components, e.g., robots, conveyor belts, and/or various sensors or actuators[,] from different suppliers, [the] an overall advantage to this[, in particular in such a case,] is that [the] investment risk is [borne] born in large part by the supplier(s). [automation] Automation system users, especially of large and cost-intensive production facilities, e.g., automobile manufactures, can hence apportion their investments to product numbers as essentially purely variable costs[,] so that major investments are distributed among several component suppliers.

In particular in cases where automation system components are procured from several different suppliers[,] and user fees must hence be paid to various suppliers, the present invention expediently provides that the first data processor comprises a device for [the] intermediate storage and/or sequencing of acquired user data.

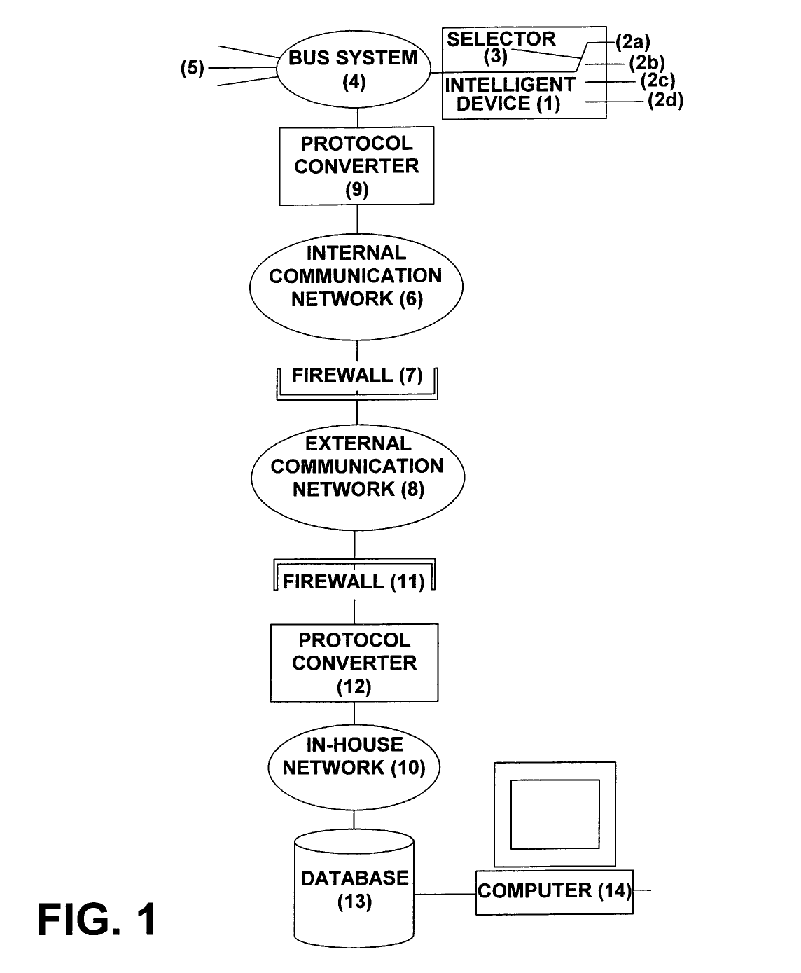

### BRIEF DESCRIPTION OF THE DRAWING

[The invention will be described in greater detail below based on an embodiment, drawing reference to the attached drawing.] The drawing shows:

[Fig.] FIG. 1 a highly simplified, basic schematic diagram of a possible system according to the present invention for determining user fees incurred from [the] use of a system.

### DETAILED DESCRIPTION OF THE PREFERRED EMBODIMENTS

Reference is made [below] to [Fig.] FIG. 1, which shows a preferred embodiment for a system according to the present invention to determine fees incurred by [a] an automation system user for [the] use of automation system components provided by [the] a supplier.

Therefore, it is presumed [for the description below] that the component supplier has delivered one or more automation system components to the automation system user, wherein the automation system component remains [the] property of the supplier or is in part been purchased by the automation system user. [Taking this embodiment as the basis, a] A user fee based in particular on use-related wear of the automation system component [was] is agreed upon between the automation system component supplier and the automation system user, depending on [the] a contract.

The automation system [not shown in the diagrammatic sketch according to Fig. 1] can essentially be any production or operating system desired, in particulars a system rooted in automation, power distribution, building system control, and/or the automotive industry. Depending on [the] a specific system, i.e., depending on whether [the] a process executed with the automation system involves monitoring, a distribution particularly of power, production or assembly, and/or some other operation, the automation system consequently encompasses production machinery and/or machine tools, conveyor belts, robots, controllers, actuators, counters, and/or correspondingly adjusted sensors and/or actuators, as required.

[$$$ hier weitermachen]

Data from the production or operating process are acquired by means of a data processor connected with the automation system. This data processor encompasses an intelligent device 1, e.g., a programmable logic control (PLC), which is either connected to, or is connectable with, the sensors, actuators, and/or other detection devices allocated to [the] a respective system [components] component.

[On Fig.] As shown in FIG. 1, connecting lines 2a to 2d link the [programmable logic control] intelligent device 1 with the detection devices (not shown), which each record specific variables that cause or represent wear on the respective automation system component or a specific subset of the automation system to be reimbursed.

In this embodiment, the [shown] intelligent device 1 encompasses a selector 3, with which a desired respective detector can be selected with the automation system process running via lines 2a to 2d. [However, it] It must be noted, however, that the intelligent device 1 can also encompass a parallel interface[,] so that it can simultaneously be connected with several detection devices.

For example, a counter is coupled via the line 2a with the intelligent device 1 to count [the] revolutions of a specific motor. The [reference number] line 2b denotes [the] a connection to a thermostat[,] which measures [the] temperatures arising in [a] an automation system component during a specific production process. In addition, the connecting lines 2c and 2d lead [form] from the intelligent device 1 to correspondingly designed detectors for measuring a liquid throughput or recording set spot welds by a corresponding tool or corresponding machine tool. Additional data relating to wear on machine components can include information about [the] number of pulses, weights bearing down on conveyor belts, encountered volumes, lengths, operating hours, machine downtimes, and/or product numbers.

[The variables] Variables to be measured or counted or data are expediently logged and temporarily stored by means of the intelligent device 1, and[,] if necessary, are then sequenced according to specific definable criteria to be described at a later point.

In this embodiment, the [programmable logic controller] intelligent device 1 is also connected with a bus system 4[,] which in this example represents part of a network allocated to the automation system. Additional devices, components, or units corresponding to the [programmable logic controller] intelligent device 1 or other devices, components, or units (not shown) are coupled with the automation system via connecting lines 5 by way of the network.

The bus system 4, and hence the [programmable logic controller] intelligent device 1, along with the system to be operated is also connected to an internal communication network 6, i.e., the Intranet of the automation system user. The internal communication network 6 of the automation system user is [in] protected [on] from the outside by a so-called firewall [(denoted by line] Y[)] of a firewall computer (not shown).

[Reference number 8 denotes an] An external communication network 8, e.g., in particular, the worldwide data communication network called the [internet,] Internet to which [the] an expert can establish a connection in a known manner from the [intranet] internal communication network 6 in order to transmit data from the [intranet] internal communication network 6 into the external communication network 8 or receive data from the external communication network 8 in the [intranet] internal communication network 6.

On [the] a side of the automation system user, i.e., on [the] a user side allocated to the automation system, the embodiment [underlying the description] also encompasses a protocol converter 9, e.g., a gateway, in order to ensure that data can be exchanged between two different network systems when two different network protocols are used by converting [the] one network format into [the] a format of the other network. In addition, a gateway can be used in particular to choose a path to a selected recipient, but also control [the] flow of data and correct errors given defective transmission framework[,] or split information to be transmitted into respectively needed packet sizes of a target network.

[Fig.] FIG. 1 also schematically depicts [the] a side of a component supplier, i.e., a supplier of at least one automation system component. This preferably encompasses an in-house network 10[,] which is protected [on] from the outside by means of a firewall 11. In addition, a preferred design includes a protocol converter 12 that works essentially the same as the protocol converter 9. A data processor encompassing a database 13 and a computer 14 is also connected to the in-house network 10 of the component supplier. Additional devices (not shown) can also be interconnected via the [intranet] in-house network 10.

To determine the user fee based on [the] actual usage, including[,] for example[,] wear caused to the component as a result, the system according to the present invention is now used to acquire [the] data or information relevant to determining the user fee, initially on the side of the automation system user as described above, via the intelligent device 1.

At this point, i.e., while determining [the] variable wear data during [the] operating time, a connection between the automation system user and the component supplier, i.e., in particular between the [networks] internal communication network 6 and the in-house network 10, is not necessary.

After a data transfer connection has been established proceeding from the internal communication network 6, the intelligent device [or programmable logic controller] 1 is used to acquire [the] data independently and prepares these data to allow the component supplier to access them. In other words, the server side is at the automation system user[,] and the client side is at the component supplier. [However, it] It is also possible, however, for the component supplier to transmit a corresponding request for [the] transfer of a data record to the automation system user beforehand, whereupon the latter transmits [the] corresponding data to the requester.

Depending on [the] a specific layout of the external communication network 8 and/or the internal communication network 6 and the in-house [networks 6 and] networks10, [the] data are prepared in the external communication network 8 by means of the data processor set up at the automation system user as a server[,] so that the component supplier can call up the data there[,] or a connection is established from the automation system user side to the component supplier side.

According to [Fig.] FIG. 1, a data transfer connection is in this example established via the external communication network 8 in [the] a direction of the in-house network 10, wherein the data are prepared using the protocol converter [8] 9 and/or the data are accessed or received using the protocol converter 12, depending on the specific layout.

After received by the component supplier, the data are gathered in the database 13 [,] and a surcharge or invoice to the user is generated cyclically based on a billing formula implemented in the computer 14.

In other words, the data are acquired by the automation system user and independently sent to the component supplier for invoicing or, as already mentioned above, in response to a corresponding request from the component supplier[, based on the application, i.e.,] essentially with the system in operation. The data itself does not have to be routinely encrypted[,] since the method according to the present invention does not involve [the] transfer of secret codes nor payments by credit card.

[The] A rate at which the data required for determining the user fee is relayed to the component supplier, or [the] time intervals in which the data record is transmitted to the component supplier, e.g., once a month, and/or which information this data record includes can [here] vary and be freely agreed upon. In addition, a unidirectional, timed handshake method is best established for the data transfer itself[,] so that the component supplier cannot alter automation system-specific parameters, e.g., setpoint values.

As a consequence, internal production data that would disclose manufacturing know-how or production numbers are not accessible to the component supplier without [the] consent or knowledge of the automation system user. As a result, the method according to the present invention essentially precludes any viewing of internal data records by an outside sub-contractor or component supplier[,] which often is not tolerated by automation system users.

In addition, it also lies within the framework of the present invention to send several component suppliers [the] respective user data relating to the automation system components they have provided. To this end, the intelligent device 1 is designed [in a practical manner] in such a way that acquired user data are presorted or sequenced specific to the component supplier[,] so as to be transmitted to [the] a respective component supplier at [the] an agreed time after an appropriate, target-oriented handshake.

Therefore, the present invention makes it possible, in particular users of complex and cost-intensive automation systems, e.g., production facilities of automobile manufacturers, to apportion their investments to product numbers as essentially purely variable costs[,] and/or distribute them among several component suppliers[,] so that [the] investment risk remains largely with the component supplier.

In addition, it is provided that wear or diagnostic information can also be obtained from the aforementioned data on the side of the component supplier by means of the data processors 12, 13, 14[,] which provide advance notice of necessary maintenance for the automation system components provided by the supplier.

Therefore, the method according to the present invention ensures that a supplier of automation system parts or machines can obtain precise information about [the] use or wear of [the] provided components without having direct access to the automation system, thereby enabling a simplified diagnosis. If wear is detected early, [these] wear related maintenance or repair jobs can be planned at the automation system user[,] and actually performed during routinely scheduled maintenance work[, for example].

1. (amended) A method for determining user fees incured by use of an automation system by an automation system user for at least one component of the automation systemprovided by at least one supplier, comprising the steps of:
a) determining user data to be allocated to the least one component of the automation system using a first data processor connected with the automation system so as to form acquired user data;
b) transmitting the acquired user data be the first data processor to a second data processor located at a component supplier side so as to form user data transmitted; and
c) determining the user fees as a function of the user data transmitted using the second data processor.

2. (amended) The method according the claim 1, wherein data concerning wear on the at least on component of the automation system are acquired as user data.

3. (amended) The method according to claim 2, wherein information about at least one of number of pulse, temperatures, weights, volumes, lenghts, revolutions, operating hours, machine downtimes, product numbers, liquid throughput, and number of spot weld is used as user data.

4. (amended) the method according to claim 3, wherein a data transfer connection running from the first data processor to the second data processor is established to transmit the user data.

5. (amended) the method according to claim 4, wherein the data transfer connection is established using a network to which the first data processor and the second data processor are linked.

6. (amended) The method according to claim 5, wherein the user data are transmitted at least one of in predefined time intervals and in response to a request previously conveyed to the first data processor by means of the second data processor.

7. (amended) The method according to claim 6, wherein an invoice based on the user fees is cyclically generated for the automation system user by means of the second data processor.

8. (amended) the method according to claim 7, wherein one of wear information and diagnostic information is obtained from the transmitted user data by means of the second data processor.

9. (amended) the method according to claim 8, wherein user data respectively allocated to the at least on component of the automation system provided by various supplier are acquired so as to form acquired user data, and the acquired user data transferred by the first data processor specific to the supplier to the second data processor located at a respective supplier side.

10. (amended) A system for determining user fees incurred from use of an automation system by an automation system user for at least one component of the automation system provided by at least one supplier, comprising:
a) a first data processor connected with the automation system with at least one device for acquiring user data to be allocated to at least one component of the automation system so as form acquired user data; and
b) a second data processor situated at a supplier side, wherein the first data processor is designed for transmitted user data, and the second data processor is designed to acquire the user fees as a function of the transmitted user data.

11. (amended) The system according to claim 10, wherein detection devices are allocated to the at least one device to acquire data concerning wear on the at least one component of the automation system.

12. (amended) The system according to claim 11, wherein the first data processor encompasses means for establishing a data transfer connection toward the second data processor, and the second data processor encompasses means for receiving user data provided via the data transfer connection.

13. (amended) The system according to claim 12, wherein at least one of the first and the second data processors is at least one of allocated to a network and encompasses a networkable gateway.

14. (amended) The system according to claim 13, wherein the first and the second data processors are linked to a shared network.

15. (amended) The according to claim 14, wherein the first data processor is designed for independent transfer of the user data in predefined time intervals.

16. (amended) The system according to claim 15, wherein the first data processor is designed for transmitting the user data in response to a request previously conveyed to the first data processor by the second data processor.

17. (amended) The system according to claim 16, wherein the second data processor cyclically generates an invoice based on the user fees for the automation system user.

18. (amended) The system according to claim 17, wherein the second data processor is designed for obtaining at lest one of wear and diagnostic information from the transmitted user data.

19. (amended) The system according to claim 18, wherein the first data processor encompasses a device for a least one of temporarily storing the acquired user data and sequencing the acquired user data.

20. (added) The method according to claim 5, wherein the network is the Internet.

21. (added) The system according to claim 11, wherein the detection devices include at least one of sensors and actuators.

22. (added) The system according to claim 14, wherein the shared network is the Internet.

23. (added) The method according to claim 1, wherein information about at least one of number of pulses, temperatures, weight, volumes, lenghts, revolutions, operating hours, machine downtimes, product numbers, liquid throughputs, and number of spot weld is used as user data.

24. (added) The method according to claim 1, wherein a data transfer connection running from the first data processor to the second data processor is established transmit the user data.

25. (added) The method according to claim 2, wherein a data transfer connection running from the first data processor to the second data processor is established to transmit the user data.

26. (added) The method according to claim 1, wherein the user data are transmitted at least one of in predefined time intervals and in response to a request previously conveyed to the first data processor by means of the second data processor.

27. (added) The method according to claim 2, wherein the user data are transmitted at least one of in predefined time intervals and in response to a request previously conveyed to the first data processor by means of the second data processor.

28. (added) The method according to claim 3, wherein the user data are transmitted at least one of in predefined time intervals and in response to a request previously conveyed to the first data processor by means of the second data processor.

29. (added) The method according to claim 4, wherein the user data are transmitted at least one of in predefined time intervals and in response to a request previously conveyed to the first data processor by means of the second data processor.

30. (added) The method according to claim 5, wherein an invoice based on the user fees is cyclically generated for the automation system user by means of the second data processor.

31. (added) The method according to claim 4, wherein an invoice based on the user fees is cyclically generated for the automation system user by means of the second data processor.

32. (added) The method according to claim 3, wherein an invoice based on the user fees is cyclically generated for the automation system user by means of the second data processor.

33. (added) The method according to claim 2, wherein an invoice based on the user fees is cyclically generated for the automation system user by means of the second data processor.

34. (added) The method according to claim 1, wherein an invoice based on the user fees is cyclically generated for the automation system user by means of the second data processor.

35. (added) The method according to claim 6, wherein one of wear information and diagnostic information is obtained from the transmitted user data by means of the second data processor.

36. (added) The method according to claim 5, wherein one of wear information and diagnostic information is obtained from the transmitted user data by means of the second data processor.

37. (added) The method according to claim 4, wherein one of wear information and diagnostic information is obtained from the transmitted user data by means of the second data processor.

38. (added) The method according to claim 3, wherein one of wear information and diagnostic information is obtained from the transmitted user data by means of the second data processor.

39. (added) The method according to claim 2, wherein one of wear information and diagnostic information is obtained from the transmitted user data by means of the second data processor.

40. (added) The method according to claim 1, wherein one of wear information and diagnostic information is obtained from the transmitted user data by means of the second data processor.

41. (added) The method according to claim 7, wherein user data respectively allocated to the at least one component of the automation system provided by various supplier are acquired so as to form acquired user data, and the acquired user data are transferred by the first data processor specific to the supplier to the second data processor located at a respective supplier side.

42. (added) The method according to claim 6, wherein user data respectively allocated to the at least one component of the automation system provided by various supplier are acquired so as to form acquired user data, and the acquired user data are transferred by the first data processor specific to the supplier to the second data processor located at a respective supplier side.

43. (added) The method according to claim 5, wherein user data respectively allocated to the at least one component of the automation system provided by various supplier are acquired so as to form acquired user data, and the acquired user data are transferred by the first data processor specific to the supplier to the second data processor located at a respective supplier side.

44. (added) The method according to claim 4, wherein user data respectively allocated to the at least one component of the automation system provided by various supplier are acquired so as to form acquired user data, and the acquired user data are transferred by the first data processor specific to the supplier to the second data processor located at a respective supplier side.

45. (added) The method according to claim 3, wherein user data respectively allocated to the at least one component of the automation system provided by various supplier are acquired so as to form acquired user data, and the acquired user data are transferred by the first data processor specific to the supplier to the second data processor located at a respective supplier side.

46. (added) The method according to claim 2, wherein user data respectively allocated to the at least one component of the automation system provided by various supplier are acquired so as to form acquired user data, and the acquired user data are transferred by the first data processor specific to the supplier to the second data processor located at a respective supplier side.

47. (added) The method according to claim 1, wherein user data respectively allocated to the at least one component of the automation system provided by various supplier are acquired so as to form acquired user data, and the acquired user data are transferred by the first data processor specific to the supplier to the second data processor located at a respective supplier side.

48. (added) The system to claim 10, wherein the first data processor encompasses means for establishing a data transfer connection toward the second data processor, and the second data processor encompasses means for receiving user data provided via the data transfer connection.

49. (added) The system according to claim 10, wherein at least one of the first and the second is at least one of allocated to a network and encompasses a networkable gateway.

50. (added) The system according to claim 11, wherein at least one of the first and the second data processors is at least one of allocated to a network and encompasses a networkable gateway.

51. (added) The system according to claim 10, wherein the first and the second data processors are linked to a shared network.

52. (added) The system according to claim 11, wherein the first and the second data processors are linked to a shared network.

53. (added) The system according to claim 12, wherein the first and the second data processors are linked to a shared network.

54. (added) The system according to claim 10, wherein the first data processor is designed for independent transfer of the user data in predefined time intervals.

55. (added) The system according to claim 11, wherein the first data processor is designed for independent transfer of the user data in predefined time intervals.

56. (added) The system according to claim 12, wherein the first data processor is designed for independent transfer of the user data in predefined time intervals.

57. (added) The system according to claim 13, wherein the first data processor is designed for independent transfer of the user data in predefined time intervals.

58. (added) The system according to claim 10, wherein the first data processor is designed for transmitting the user data in response to a request previously conveyed to the first data processor by the second data processor.

59. (added) The system according to claim 11, wherein the first data processor is designed for transmitting the user data in response to a request previously conveyed to the first data processor by the second data processor.

60. (added) The system according to claim 12, wherein the first data processor is designed for transmitting the user data in response to a request previously conveyed to the first data processor by the second data processor.

61. (added) The system according to claim 13, wherein the first data processor is designed for transmitting the user data in response to a request previously conveyed to the first data processor by the second data processor.

62. (added) The system according to claim 14, wherein the first data processor is designed for transmitting the user data in response to a request previously conveyed to the first data processor by the second data processor.

63. (added) The system according to claim 10, wherein the second data processor cyclically generates an invoice based on the user fees for the automation system user.

64. (added) The system according to claim 11, wherein the second data processor cyclically generates an invoice based on the user fees for the automation system user.

65. (added) The system according to claim 12, wherein the second data processor cyclically generates an invoice based on the user fees for the automation system user.

66. (added) The system according to claim 13, wherein the second data processor cyclically generates an invoice based on the user fees for the automation system user.

67. (added) The system according to claim 14, wherein the second data processor cyclically generates an invoice based on the user fees for the automation system user.

68. (added) The system according to claim 15, wherein the second data processor cyclically generates an invoice based on the user fees for the automation system user.

69, (added) The system according to claim 10, wherein the second data processor is designed for obtaining at least one of wear and diagnostic information from the transmitted user data.

70. (added) The system according to claim 11, wherein the second data processor is designed for obtaining at least one of wear and diagnostic information from the transmitted user data.

71. (added) The system according to claim 12, wherein the second data processor is designed for obtaining at least one of wear and diagnostic information from the transmitted user data.

72. (added) The system according to claim 13, wherein the second data processor is designed for obtaining at least one of wear and diagnostic information from the transmitted user data.

73. (added) The system according to claim 14, wherein the second data processor is designed for obtaining at least one of wear and diagnostic information from the transmitted user data.

74. (added) The system according to claim 15, wherein the second data processor is designed for obtaining at least one of wear and diagnostic information from the transmitted user data.

75. (added) The system according to claim 16, wherein the second data processor is designed for obtaining at least one of wear and diagnostic information from the transmitted user data.

76. (added) The system according to claim 10, wherein the first data processor encompasses a device for at least one temporarily storing the acquired user data and sequencing the acquired user data.

77. (added) The system according to claim 11, wherein the first data processor encompasses a device for at least one temporarily storing the acquired user data and sequencing the acquired user data.

78. (added) The system according to claim 12, wherein the first data processor encompasses a device for at least one temporarily storing the acquired user data and sequencing the acquired user data.

79. (added) The system according to claim 13, wherein the first data processor encompasses a device for at least one temporarily storing the acquired user data and sequencing the acquired user data.

80. (added) The system according to claim 14, wherein the first data processor encompasses a device for at least one temporarily storing the acquired user data and sequencing the acquired user data.

81. (added) The system according to claim 15, wherein the first data processor encompasses a device for at least one temporarily storing the acquired user data and sequencing the acquired user data.

82. (added) The system according to claim 16, wherein the first data processor encompasses a device for at least one temporarily storing the acquired user data and sequencing the acquired user data.

83. (added) The system according to claim 17, wherein the first data processor encompasses a device for at least one temporarily storing the acquired user data and sequencing the acquired user data.
